(19) United States
(12) Patent Application Publication
(10) Pub. No.: US 2023/0401104 A1
(43) Pub. Date: Dec. 14, 2023

(54) METHOD AND SYSTEM TO IDENTIFY TIME-BASED PATTERNS IN RESOURCE MANAGEMENT OPERATIONS

(71) Applicant: Trovata, Inc., Solana Beach, CA (US)

(72) Inventors: Francisco PerezLeon, Richmond, CA (US); Joseph Drambarean, Encinitas, CA (US)

(73) Assignee: Trovata, Inc., Solana Beach, CA (US)

(21) Appl. No.: 18/331,040

(22) Filed: Jun. 7, 2023

Related U.S. Application Data
(60) Provisional application No. 63/350,350, filed on Jun. 8, 2022.

(51) Int. Cl. G06F 9/50

(52) U.S. Cl. CPC G06F 9/5077; G06F 9/5072

(57) ABSTRACT

A system and method are described that receive digital records received from disparate computer systems wherein the records are heterogeneous in format and thus noisy. The systems utilize mapping to higher-dimensional vector spaces, clustering, reduction, and autocorrelation to identify and extract groups of related resource management operations of a time-recurrent nature from the noise of the system inputs.

### CROSS-REFERENCE TO RELATED APPLICATIONS

This application claims the benefit of U.S. provisional patent application Ser. No. 63/350,350 filed on Jun. 8, 2022, the contents of which are incorporated herein by reference in their entirety.

### BACKGROUND

As corporate institutions grow in size and complexity, the volume of resources managed and the number of digital operations performed as part of their management expands exponentially, and patterns become harder to identify. The data digital records provided by separate institutions across separate business jurisdictions may bear numerous similarities that are obscured by differing labels, reporting formats, metadata, etc. A single institution's resource management operations and the information provided describing them may also evolve over time as systems and vendors change.

Such metadata discrepancies and other superficial differences may obscure the very information an entity interacting with and managing a large volume of resources may wish to examine, track, and act upon. As one example, conventional approaches are inadequate to readily accommodate the different standards that exist across all of the different corporate checking account types found throughout the world.

For this reason, there is a need for a system capable of quickly and comprehensively analyzing these enormous and disparate data streams for similarities and patterns among the resource management operations represented, including the ability to detect patterns of recurring resource management operation.

### BRIEF SUMMARY

In one aspect, a system includes an interface to receive digital records from a plurality of disparate computer server systems. The system also includes logic to transform the digital records from the disparate computer server systems into visualizations and anchor tags by mapping the digital records to feature vectors in a higher than three-dimensional vector space, calculating Hamming Distances between the feature vectors, forming labeled clusters of the feature vectors in the higher than three-dimensional vector space using a density-based spatial clustering of applications with noise (DBSCAN) algorithm, and Hamming Distances, autocorrelating the labeled clusters having common characteristics to identify transactions that recur on a predetermined time interval, thereby identifying time-recurrent labeled clusters, identifying the anchor tags, where the anchor tags represent characteristics of groups of time-recurrent labeled clusters useful for resource management operations, and presenting the visualizations and the anchor tags to a user for selection of the anchor tag. The system also includes logic to apply the anchor tags to the time-recurrent labeled clusters and to facilitate resource management operations by receiving an anchor tag selection signal from the user includes at least one of selecting a suggested anchor tag, creating a custom anchor tag, and selecting no anchor tag, applying the anchor tag to the group of time-recurrent labeled clusters based on the anchor tag selection signal, thereby creating an anchor tagged group of time-recurrent labeled clusters, generating a time-recurrent cluster monitoring signal based on an applied anchor tag, and initiating the resource management operations based on the time-recurrent cluster monitoring signal. This system and a method for its use are disclosed.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a system 100 in accordance with one embodiment.

FIG. 2 depicts a distributed computing platform 200 in accordance with one embodiment.

FIG. 3 depicts a controller configuration system 300 in accordance with one embodiment.

FIG. 4 depicts a logic process 400 in accordance with one embodiment.

FIG. 5 depicts a logic process 500 in accordance with one embodiment.

FIG. 6 illustrates a routine 600 in accordance with one embodiment.

FIG. 7 illustrates a routine 700 in accordance with one embodiment.

FIG. 8 depicts visualizations 800 in accordance with one embodiment.

FIG. 9 illustrates a client server network configuration 900 in accordance with one embodiment.

FIG. 10 is an example block diagram of a computing device 1000 that may implement aspects of the disclosed systems and processes.

### DETAILED DESCRIPTION

Digital records may be received from disparate computer systems and may be heterogeneous in terms of the format of the “fingerprint” that characterizes them. It therefore becomes technically challenging to identify and extract groups of related transactions of a recurring nature from the noise of the system inputs.

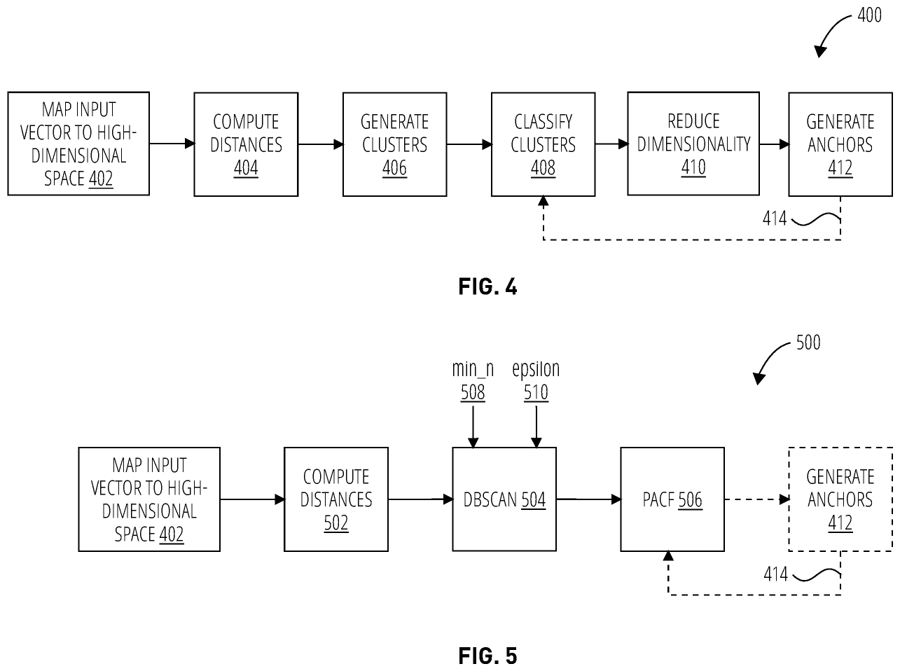

Embodiments of a distributed computing platform are disclosed to seamlessly automate operational tasks across functional areas within an enterprise. The platform may implement a scalable online system for data ingest, indexing, and outflow, with performance-enhancing rate matching between each stage. The disclosed system may be configured with named hierarchical filters. As new transactions occur and new digital records are received, indexing may be applied across a decoupling boundary, and hierarchical filters (called “tags” or “anchor tags”) may be applied after indexing for enhanced performance and customization without necessitating the instrumentation of each transaction. In one embodiment the systems may utilize the anchor tags generated by the algorithms described in conjunction with FIG. 4-FIG. 8.

Conventional indexing approaches write fields into each transaction that matches a condition (a “tag”). “Tag” refers to a label associated with a filter condition. An example of a filter condition is a Structured Query Language or Boolean logic setting. An example of a tag (the format is just an example) is: September Large Transactions->“amount>$100 AND 9/1/2019<=date<=9/30/2019”. This may degrade performance as edits or changes to the tag or any aspect of the parameters utilized by the tag may result in the system scanning through the entirety of the index and making changes to each record utilizing the tag, and then re-indexing.

The disclosed system exhibits improved performance by de-coupling indexing from the parametric constraints of tagging. Thus the disclosed system may better match indexing performance with a rate of data ingest and/or data outflow. Multilevel hierarchical tags may be configured so that a parent-child relationship is established through the application of iterative refinements. The indexing may operate asynchronously from the data ingest across a decoupling boundary. When ingestion and normalization complete, a push notification may be applied across the decoupling boundary to trigger operation of the indexing module to update the search index based on anchor tags in relational tables of the normalized data set. Anchor tags may be tags assigned or otherwise identified as having particular use in resource management operations. Such anchor tags may mark groups of clusters associated with time-recurrent (weekly, bimonthly, monthly) resource management operations, operations associated with resources of particular business significance, resources associated with a particular business division, etc. The system may provide on-demand retrieval by client devices of highly customized information for use in analytics, reporting, forecasting, and automated transactional operations, based on recently and periodically acquired data sets from disparate computer server systems with improved performance and lower latency than is available with conventional approaches.

As subsequent figures are described, certain terminology is used. Explanation for some of that terminology is included here.

“Disparate computer server systems” refers to physically distinct and separate computer systems operated by distinct and separate companies and accessible over distinct and separate communication channels from one another. “Process” refers to software that is in the process of being executed on a device. “Ingest module” refers to logic that opens and operates communication sessions to pull data from disparate computer server systems. “Outflow module” refers to logic that services on-demand or scheduled requests for structured data for utilization by client apps and applications to generate structured user interfaces and graphical visualizations. “User” refers to a human operator of a client device. “Connection scheduler” refers to logic that establishes connections between disparate computer server systems according to a connection cadence determined by cadence rules. “Connection cadence” refers to the rate and/or frequency of connection establishment for data transfers between disparate computer server systems. “Connection scheduler” refers to logic that establishes connections between disparate computer server systems according to a connection cadence determined by cadence rules. “Cadence rule” refers to a logic setting that controls a rate and/or frequency of connection establishment and data transfers between disparate computer server systems. “Web integration service” refers to a container for a web service, providing an API between the web service and external logic.

“Normalizing module” refers to logic that transforms data received from disparate computer server systems in various and different formats into a common format. “Web service” or “service” refers to a service that listens for requests (typically at a particular network port) and provides functionality (e.g., Javascript, algorithms, procedures) and/or data (e.g., HTML, JSON, XML) in response to the requests.

“Hot connection module” refers to logic that maintains a communication session open across configured timeout conditions. “Metadata control setting” refers to settings that control the establishment of secure connections between disparate computer server systems. “Indexing module” refers to logic that transforms received data signals into a searchable index. “Arbitrator” refers to logic that manages contention for a shared computing, communication, or memory resource in a computer system. “Outflow engine” refers to engine logic utilized by the outflow module. An engine is a logic component optimized to move and/or transform data according to specific algorithms with high performance.

The apparatuses, systems, and/or methods disclosed herein, or particular components thereof, may in some embodiments be implemented as software comprising instructions executed on one or more programmable device. “Programmable device” refers to any logic (including hardware and software logic) who's operational behavior is configurable with instructions. By way of example, components of the disclosed systems may be implemented as an application, an app, drivers, or services. “Application” refers to any software that is executed on a device above a level of the operating system. An application will typically be loaded by the operating system for execution and will make function calls to the operating system for lower-level services. An application often has a user interface, but this is not always the case. Therefore, the term “application” includes background processes that execute at a higher level than the operating system. “App” refers to a type of application with limited functionality, most commonly associated with applications executed on mobile devices. Apps tend to have a more limited feature set and simpler user interface than applications as those terms are commonly understood in the art. “Driver” refers to low-level logic, typically software, that controls components of a device. Drivers often control the interface between an operating system or application and input/output components or peripherals of a device, for example. “Service” refers to a process configurable with one or more associated policies for use of the process. Services are commonly invoked on server devices by client devices, usually over a machine communication network such as the Internet. Many instances of a service may execute as different processes, each configured with a different or the same policies, each for a different client.

The term “subroutine” refers to a module configured to perform one or more calculations or other processes. In some contexts, the term “subroutine” refers to a module that does not return a value to the logic that invokes it, whereas a “function” returns a value. However herein the term “subroutine” is used synonymously with “function”.

“Task” refers to one or more operations that a process performs. However, the system need not necessarily be accessed over a network and could, in some embodiments, be implemented by one or more app or applications on a single device or distributed between a mobile device and a computer, for example. “Computer” refers to any computing device. Examples of a computer include, but are not limited to, a personal computer, a laptop, a tablet, a desktop, a server, a main frame, a super computer, a computing node, a virtual computer, a hand held device, a smart phone, a cell phone, a system on a chip, a single chip computer, and the like.

“Plug-in” refers to Software that adds features to an existing computer program without rebuilding (e.g., changing or re-compiling) the computer program. Plug-ins are commonly used for example with Internet browser applications.

Digital records may be received from disparate computer systems and may be heterogeneous in terms of the format of the “fingerprint” that characterizes them. It therefore becomes technically challenging to identify and extract groups of related transactions of a recurring nature from the noise of the system inputs.

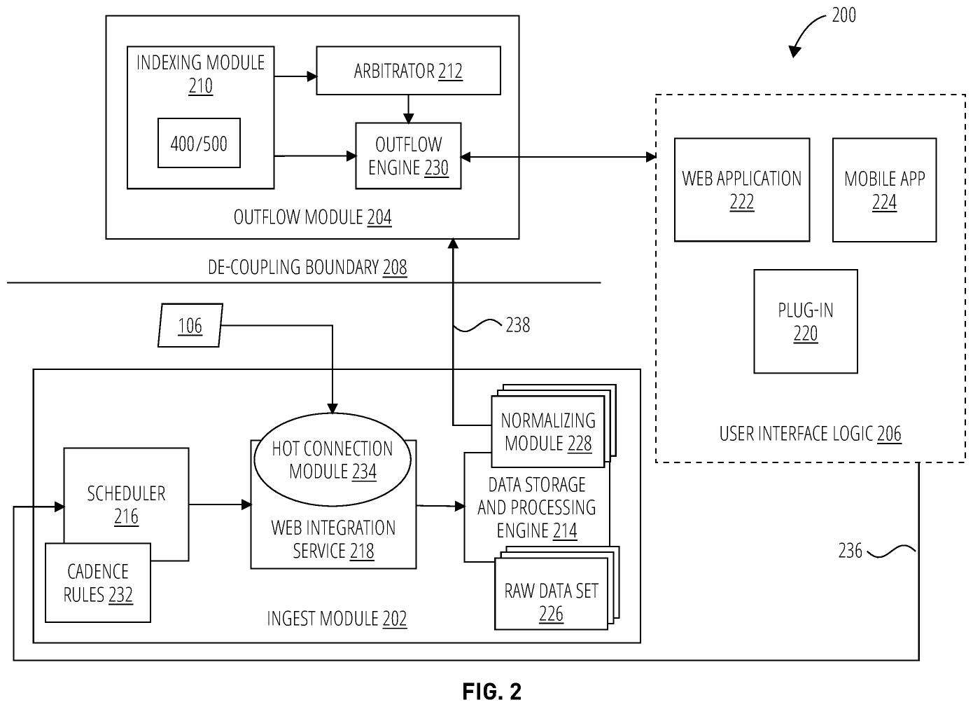

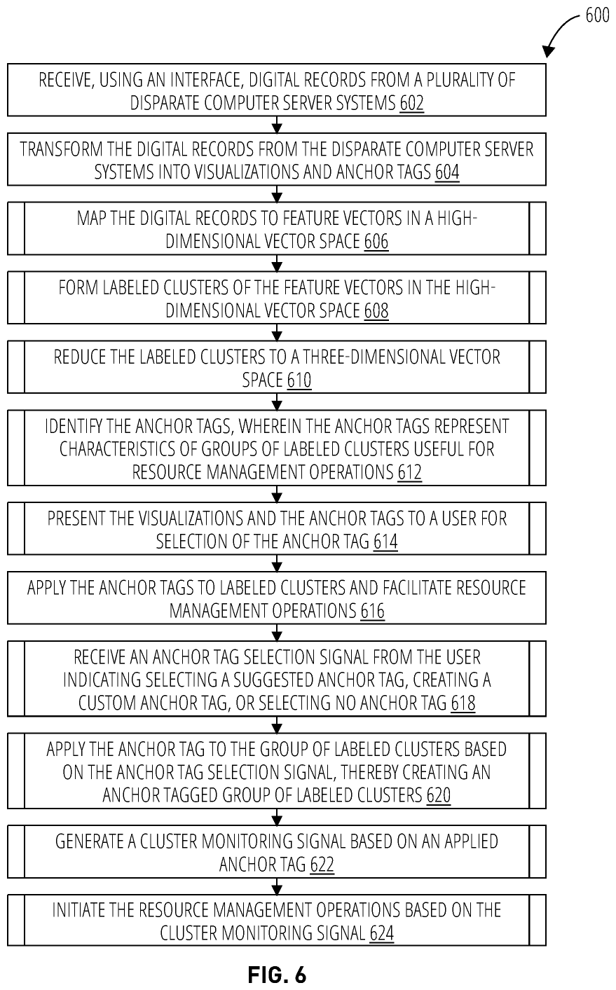

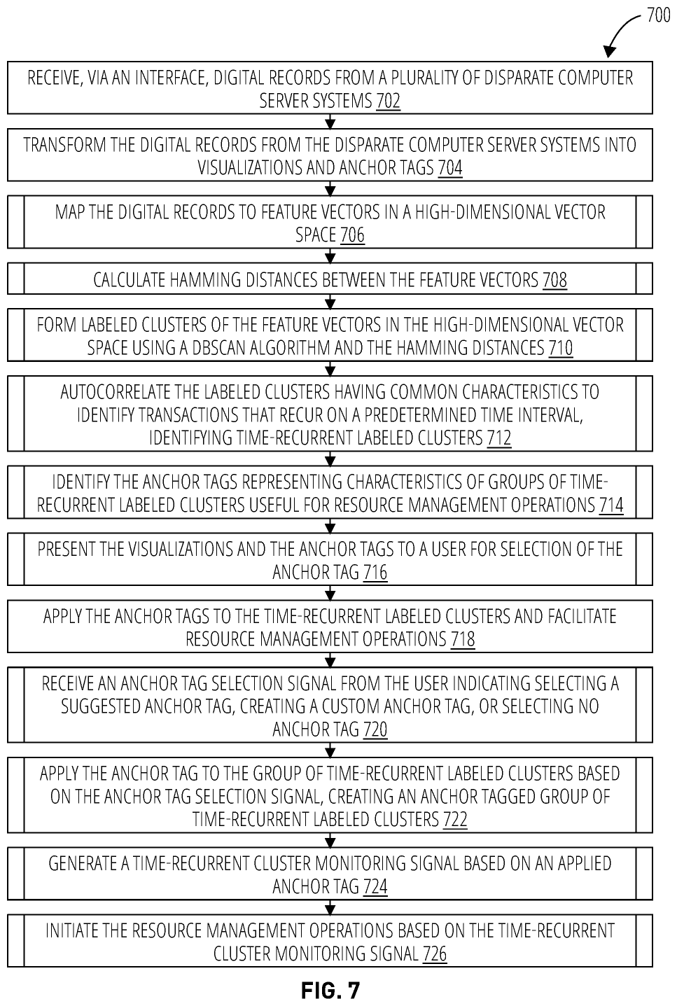

An improvement in communication and operational bandwidth may be achieved due to a reduction in the size of data packets exchanged and operated upon as compared with conventional systems. The improvement in bandwidth may lead to fewer system operational latencies and thus improved performance. For example as depicted in FIG. 2, FIG. 4, FIG. 5, FIG. 6, and FIG. 7, a reduction is achieved in the size of data packets operated upon within the system and communicated from the outflow module to user interface logic such as are shown in FIG. 2 due to the vectorization, clustering, and dimensional reduction performed in the improved system by at least clustering 406, NLP classification 408, reduction 410 in one embodiment and PACF 506 in another embodiment.

The system may be operationally more robust than conventional systems due to having a reduced number of branch points or decision points. The reduced branching or decision complexity may improve system performance and/or reliability, and may reduce the possibility of the system becoming unstable. For example as depicted in FIG. 4, FIG. 5, FIG. 6, and FIG. 7, an improvement is achieved in complexity due to the ability of the improved system to identify operations of interest among the resource management options and to process and execute decisions upon anchor tagged groups of clusters rather than individual feature vectors. The cluster generation, classification, and dimension reduction operations of FIG. 4 and the clustering and autocorrelation operations of FIG. 5 act to greatly reduce the data points requiring independent decision and management operations as a user interacts with the system to perform resource management operations via the user interface logic 206 of FIG. 2.

The system comprises reduced processing and communication bottlenecks than do conventional systems. This may result in greater operational efficiencies such as reduced latency and/or propagation delays between components. For example as depicted in FIG. 2, a bottleneck reduction is achieved due to the hot connection capabilities of the web integration service 218, as well as the decoupling de-coupling boundary 208 found in the ingest module 202, in the improved system. The web integration service 218 may be able to bring in digital records in real time from multiple disparate computer server systems without need for direct human intervention and monitoring, as is common in conventional systems. The decoupling de-coupling boundary 208 allows the ingest module 202 and outflow module 204 to operate independent of the input and out put data rates experienced by either.

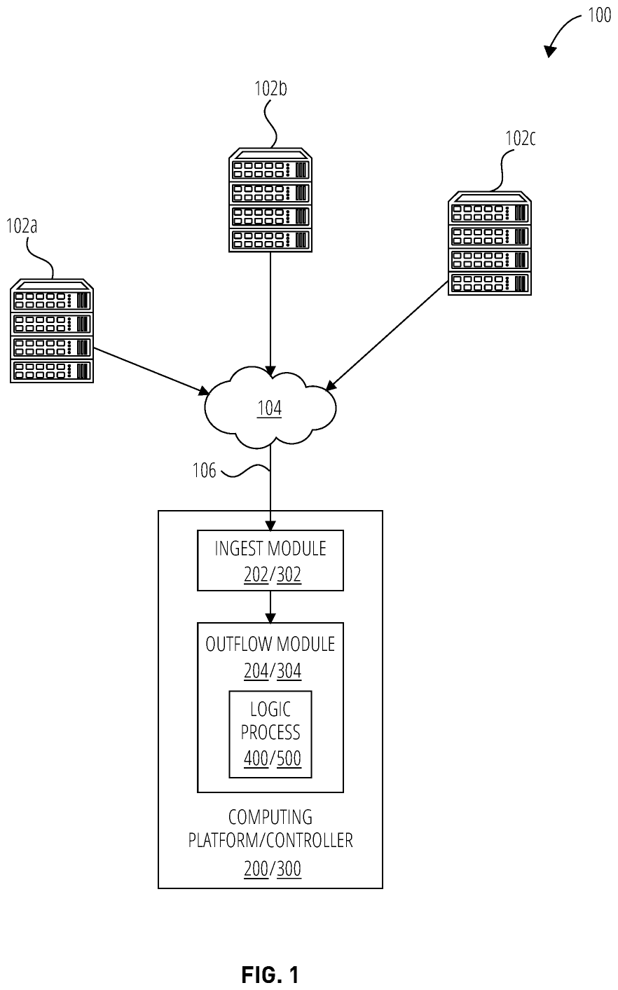

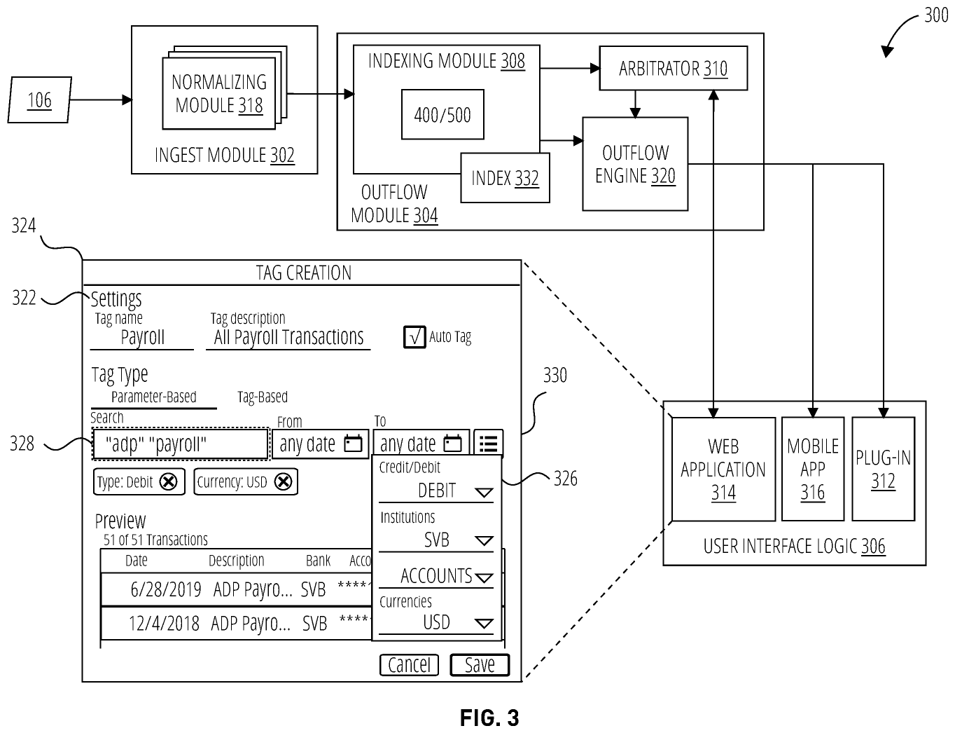

FIG. 1 illustrates a system 100 in accordance with one embodiment. The system 100 comprises disparate computer server systems 102a through 102c, in wired or wireless communication with a network 104, and able thus to send digital records 106, to a computation system such as a distributed computing platform 200 and/or a controller configuration system 300, as are described in greater detail with respect to FIG. 2 and FIG. 3, respectively. It will be readily understood by one of skill in the art that any number of computer server systems may be thus networked and able to send digital records 106 in the disclosed system 100.

The distributed computing platform 200 and/or controller configuration system 300 may both include an ingest module (ingest module 202 and ingest module 302 respectively), the operation of which is described in greater detail below. The ingest module 202 and/or ingest module 302 may receive the digital records 106, and may perform various processing steps described below before providing their processed outputs to an outflow module comprised in the distributed computing platform 200 and/or controller configuration system 300 (outflow module 204 and outflow module 304, respectively).

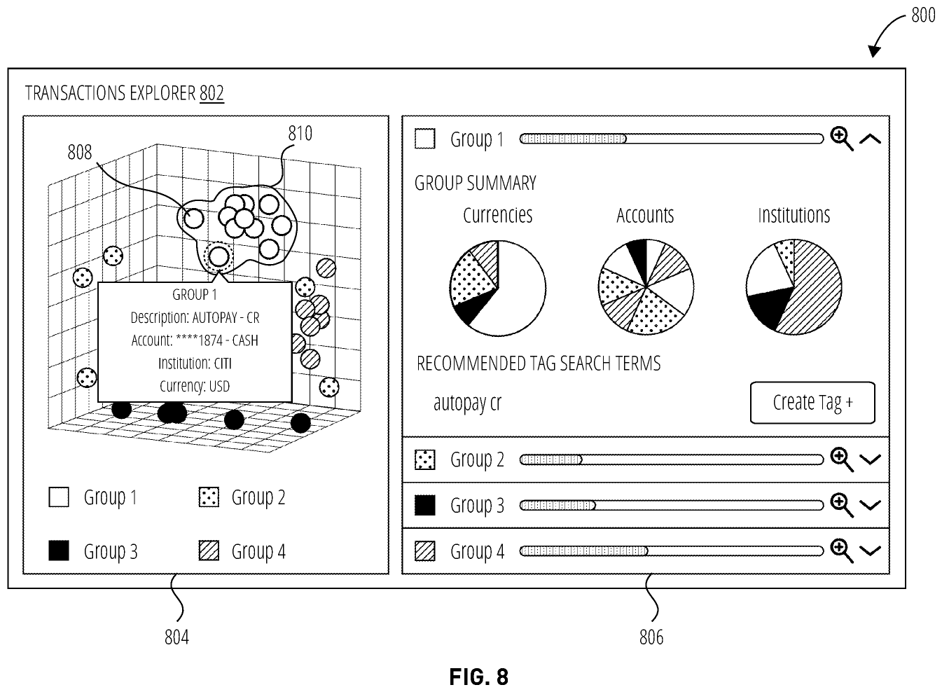

The outflow module 204 and/or outflow module 304, described in greater detail with respect to FIG. 2 and FIG. 3, respectively, may receive the data from their associated ingest module 202 and/or ingest module 302, and may act upon this data according to the steps of logic process 400 and/or logic process 500. These logic processes are described in greater detail with respect to FIG. 4 and FIG. 5, respectively. In this manner, the disclosed solution may act upon transaction data to provide visualizations 800 and anchor tags, as will be described in greater detail with respect to FIG. 3, FIG. 6, FIG. 7, and FIG. 8. In this manner, a user may readily view, assess, and act upon corporate resource management data from disparate computer server systems (e.g., banking institutions, property management services, staffing entities, etc.) using a system that may be self-training and self-improving as additional digital records 106 are received across time.

FIG. 2 depicts a distributed computing platform 200 in one embodiment. At a high level, the distributed computing platform 200 comprises an ingest module 202 and an outflow module 204. The ingest module 202 and outflow module 204 may exchange data and control signals with user interface logic 206. The ingest module 202 and outflow module 204 may interoperate across a de-coupling boundary 208. “De-coupling boundary” refers to an interface between two communicating logic components that decouples the rate at which one component transforms its inputs to outputs from the rate at which the other component transforms its inputs to outputs.

The ingest module 202 may be operatively coupled to the user interface logic 206 and may activate on a schedule to pull data from disparate computer server systems. “Disparate computer server systems” refers to physically distinct and separate computer systems operated by distinct and separate companies and accessible over distinct and separate communication channels from one another. The ingest module 202 may be operatively coupled to the outflow module 204 and may pass normalized data across the de-coupling boundary 208 to the outflow module 204. The outflow module 204 may be communicatively coupled to the user interface logic 206 allowing a user to instrument a pipeline of normalized data from the ingest module 202 to the outflow module 204 and from there to the user interface logic 206 using hierarchical filter control settings, referred to herein as “tags”.

The user interface logic 206 depicted here includes one or more of a mobile application 224, a web application 222, and a plug-in 220. The mobile application 224 and the web application 222 may allow user interaction with and configuration of the distributed computing platform 200. The plug-in 220 may provide an interface between a restful logic component such as Excel and the distributed computing platform 200.

The ingest module 202 comprises a connection scheduler 216, a web integration service 218, and a data storage and processing engine 214. The ingest module 202 may be a serverless implementation that activates and deactivates services dynamically to ingest raw data from disparate computer server systems into a normalized format, according to individual schedules for each of the disparate computer server systems. “Serverless” refers to a computing system architected such that performance scalability is enabled by configuring, either automatically or via manually configured control settings, units of resource consumption (e.g., computational units, communication bandwidth, memory) rather than by adding or removing entire computer servers.

Data ingest may be controlled by a connection scheduler 216 and Cadence rules 232. The connection scheduler 216 may utilize the Cadence rules 232 to operate the web integration service 218, which may open connections and pull data for further processing by the data storage and processing engine 214. In one embodiment, the user may be able to use the user interface logic 206 to send a configuration signal 236 to induce the connection scheduler 216 to perform a real-time query of its data sources, or to configure the scheduled interval for periodic queries.

A hot connection module 234 may manage the connections utilized by the web integration service 218 to pull data from the disparate computer server systems. The web integration service 218 may invoke a dynamic application programming interface (API) to each of the disparate computer server systems; each API may be specific to a particular server system and the connection via the API may be controlled and maintained by the hot connection module 234.

The data storage and processing engine 214 may operate a normalizing module 228 on a raw data set 226 received from the web integration service 218. This may result in a normalized data set with consistent fields regardless of the specific format of the raw data sets from different ones of the disparate computer server systems. The normalizing module 228 may utilize a dynamically activated set of algorithms specific to the format of the data source. These algorithms may perform functions such as file conversion, parsing, and analysis, and are well known in the art.

The connections established and maintained by the hot connection module 234 are “hot connections” that are opened and closed dynamically such that the connection is made persistent per rules established by institution-specific security protocols (e.g., OAuTH, tokenized, dual authentication etc.). These rules may be configured in the hot connection module 234 or the connection scheduler 216 or both.

The connection scheduler 216 may act as a throttle/rate limiter based on a hierarchical prioritization of at least the following parameters:
1. Institution restrictions on data access (connections or data amounts) per time interval
2. Data availability or update schedules
3. User access privileges for the institution (what data are they allowed access to and how often)
4. Institutional limits on data transfer amounts/rates per session

Normalized data 238 may be communicated from the ingest module 202 to the outflow module 204 across the de-coupling boundary 208. The de-coupling boundary 208 may be a computer resource utilization boundary separating the operation of the ingest module 202 and the outflow module 204. The de-coupling boundary 208 may allow the ingest module 202 to operate independently and at a different rate from the outflow module 204; particularly the indexing module 210 of the outflow module 204 may operate asynchronously from the ingest and normalization of data by the ingest module 202.

The outflow module 204 may comprise an indexing module 210, an arbitrator 212, and an outflow engine 230. The outflow module 204 may be a serverless implementation for data delivery for which services are activated and deactivated dynamically per client. The indexing module 210 may be operatively coupled to the arbitrator 212 which manages contention for the outflow engine 230 among the various clients requesting data via the user interface logic 206. The arbitrator 212 may also control the operation of the outflow engine 230 based on hierarchical filters configured via the web application 222.

The distributed computing platform 200 may, in one embodiment, serve as an example of a serverless cloud computing platform. “Serverless cloud computing platform” refers to “Serverless cloud computing platform” refers to a set of processing hardware (processors), memory hardware (non-volatile memory and/or volatile memory), storage hardware (storage devices), networking hardware, software, firmware, systems, subsystems, components, circuits, and logic configured to implement a cloud computing execution model. (Search “serverless computing.” on Wikipedia.com Feb. 5, 2020. Modified. Accessed Feb. 5, 2020.) Examples of components, systems, architectures, functionality, and logic that may be included in a serverless cloud computing platform include AWS Lambda, AWS Dynamo, AWS RDS, AWS S3, AWS Elastic Search, Amazon SNS, and/or Amazon Gateway.

FIG. 3 depicts a controller configuration system 300 in one embodiment. The controller configuration system 300 may comprise an ingest module 302 including a normalizing module 318, an outflow module 304, and user interface logic 306. The outflow module 304 may include an indexing module 308, an arbitrator 310, an outflow engine 320, and an index 332. The user interface logic 306 may include a plug-in 312, a web application 314, and a mobile application 316. The web application 314 may include tagging logic 330, including tag descriptor settings 322, a dynamic preview window 324, metadata 326, and tag parameters 328.

The controller configuration system 300 as depicted includes some components of the distributed computing platform 200 but also includes additional aspects. The web application 314 is depicted in more detail and may comprise tagging logic 330 that provides a tag descriptor setting 322, tag parameters 328, metadata 326, and a dynamic preview window 324. Elements of the controller configuration system 300 having the same designations as parts of distributed computing platform 200 may in one embodiment have the same properties and behaviors as described with respect to FIG. 2, where those elements are introduced.

The tagging logic 330 may allow the configuration of tags comprising filter settings. The tag descriptor setting 322 may be a label to concisely reference the tag for future use. The tag parameters 328 may act along with the metadata 326 form filter settings to apply to the normalized data generated by the ingest module 302. The metadata 326 may identify specific institutions, accounts, currencies, and/or transaction types. Other types of metadata 326 may also be selectable. The dynamic preview window 324 may display normalized data potentially associated with the tag as it is currently configured. To form a hierarchical filter, one or more tag descriptor setting 322 for existing tags may be set in the tag parameters 328. The tag parameters 328 may be generated in many ways, including explicit selections, search queries, and natural language inputs. The tag parameters 328 may be applied as “fuzzy” parameters as that term is normally understood in the art. Some of the tag parameters 328, such as the institutions and accounts, may be “anchor” settings that associate with specific records in one or more database comprising the normalized data.

Substantial performance improvements may be realized by building the search index 332 based on relational tables in the normalized data set that includes fields for the anchor tag parameters 328, and then filtering search results generated from the index 332 for tag parameters 328 that are not anchored but instead implemented as filter restrictions applied to the outflow engine 320. The filter restrictions applied to the outflow engine 320 based on tag parameters 328 may be formed dynamically (as client requests are received). The tag parameters 328 that are applied as filter settings may for example implement whitelist and blacklist conditions on the data communicated by the outflow engine 320.

The indexing module 308 may be asynchronously coupled to the normalizing module 318 to receive the normalized data. The web application 314 may be communicatively coupled to the arbitrator 310 to configure the arbitrator 310 with one or more configured tags for the outflow engine 320 to apply to the index 332 generated by the indexing module 308. The outflow engine 320 may be operatively coupled to communicate the filtered data sets thus generated to the mobile application 316 and/or the plug-in 312 (for example).

FIG. 4 illustrates a logic process 400 in one embodiment. The logic process 400 may be used to perform a routine 600 described in additional detail with respect to FIG. 6. Referring to the logic process 400 depicted in FIG. 4, these challenges may be addressed by systems that transform digital records into vectors within a higher than three-dimensional vector space (e.g., 300+ dimensions) using mapper 402 (e.g., word2vec). Prior to the transformation, the inputs may be processed through a parser to generate a large sample set (e.g., a “bag of samples”) where each sample comprises a sequence of one or more symbols. This large set may then be high-pass filtered to reduce its contents to the highest-frequency components. The filtered set may then be utilized as the basis for mapping the inputs to the higher-dimensional space. The system may then determine mathematical distances between the transactions in the higher than three-dimensional vector space (distance metric 404). Calculation of mathematical distance between vectors is well understood in the art, and may include calculating Euclidean distance, Hamming distance, Manhattan distance, Minkowski distance, or other well understood vector calculations.

So-called “hard” clustering techniques may be applied to determine groups of similar transactions (clustering 406). The clustering may be executed repeatedly with different settings for cluster count until a “cliff” is identified at which there is a maximum change (e.g., increase) in cluster density between iterations (relatively). This point may indicate a desired cluster density for utilization by the subsequent logic process 400 stages. Meaningful clusters that are identified may be passed through a summary stage that applies Natural Language Processing (NLP), Natural Language Understanding (NLU), and machine learning algorithms (NLP classification 408) to label the contents of a cluster in a meaningful way. In one embodiment, the NLP, NLU, and machine learning may include topical and/or subject analysis, keyword extractors, sentiment analyzers, word cloud generators, Latent Dirichlet Allocation (LDA), etc. Readily available solutions include Amazon Comprehend, IBM Watson, Google Cloud NPL, Aylien, MeaningCloud, BigML, etc.

In one embodiment, a meaningful cluster may be a cluster that falls within learned or selected parameters for cluster size and density. For example, merchants or actions that characterize the transactions within a cluster may be identified by the NLP classification 408 as a label to utilize for the cluster. Topical or subject analysis algorithms known in the art may be utilized for this purpose. The label for a cluster may be utilized in search engines and/or by search indexes. The labeling algorithm may utilize unsupervised machine learning networks, for greater efficiency.

Reduction techniques may then be applied to the higher than three-dimensional vector space (reduction 410). In one embodiment, the higher than three-dimensional vector space may be collapsed into three dimensions. For example, a t-distributed stochastic neighbor embedding (t-SNE) algorithm may be utilized for this purpose. This step may be carried out in such a way that loss is minimized. The resulting dimensions may represent the principal components of the vectors in the higher-dimensional space. In particular, the dimensions of the condensed vectors may reflect contributions from each of the higher dimensions. Reducing the number of dimensions to three may allow more efficient visualization of the distribution without excessive filtering or interactivity to establish placement (see for example the interactive cluster visualization and visualization of various cluster attribute distributions depicted in FIG. 8).

Outputs from the topical analysis stage (also depicted in the FIG. 8 visualizations) may be applied as “anchors” or “anchor tags” (generate anchors 412) in normalized aggregated inputs from distributed online systems, in order to provide more efficient indexing and scalability in the system, and to forecast and manage future resource inflows and outflows. In one embodiment, such anchor tags 414 may be fed back to NLP classification 408 in order to facilitate more efficient classification of clusters developed from newly input digital records. Anchor tags may also be applied to meaningfully identify clusters representing resource transactions having particular business ramifications. As additional transactions are vectorized and included in the cluster, trends in how those transactions differ from previous transactions in the cluster may cause the cluster to drift in one or more dimensions. Quickly identifying drift along significant dimensions of clusters associated with some anchors may allow more timely detection of a need for business decisions.

For example, a user may be reviewing a large set of transactions, and may use an interface providing visualizations 800 such as are illustrated in FIG. 8 to identify a cluster that is material to a particular cash flow. A tag may be applied representing that cluster, allowing the transactions in that cluster to be so labeled in perpetuity. A directional change in that cluster may indicate that a cash flow trend is going down for that cluster. The system may be configured to recognize such a directional change and provide the user with an alert. As a result of that directional change, the user may be made aware that there is a need to move money to counteract this change. In one embodiment, look-ahead may be possible, such that a forecasted shift that counteracts the recognized downward trend may provide a predicted amount that, if moved, may positively impact the directionality of that cluster which has business ramifications in this context, thus adequately accounting for and mitigating the negative effects of such a trend.

FIG. 5 illustrates a logic process 500 in one embodiment. The logic process 500 may be used to perform a routine 700 described in additional detail with respect to FIG. 7. Referring now to the logic process 500 depicted in FIG. 5, systems are also disclosed utilizing embodiments of an algorithm to detect recurring movements and exchanges of resources utilizing a novel combination of statistical and clustering methods.

Mathematical distances may be computed in a first stage of an algorithm, and a distance metric 502 may be specifically chosen and configured to detect groups that belong to the same set of recurring transactions. Conventional sequence matching techniques may be insufficient because digital records from heterogeneous computer system sources comprise a high signal-to-noise ratio. Instead, in one embodiment, a Hamming Distance is utilized providing control over the sensitivity of the clustering algorithm in an interpretable manner. Hamming distance is a metric for comparing two binary data strings. When comparing two binary strings of equal length, Hamming distance is the number of bit positions in which the two bits are different. Hamming distance is used for error detection or error correction when data is transmitted over computer networks. It is also used in coding theory for comparing equal length data words.

The second stage of the algorithm may generate transaction vectors using a process similar to the higher than three-dimensional vector space vector mapper 402 described above. The algorithm may apply density-based spatial clustering of applications with noise (DBSCAN 504), a non-hard clustering algorithm that does not require the modeler to be configured with an exact number of clusters a priori. Also with DBSCAN 504, not every vector need be placed in a cluster, so that the algorithm performs a form of noise filtering during the process of forming the clusters. DBSCAN 504 may be configured with two parameters: (1) a minimum number of data points that make up a cluster (min_n 508), and (2) a maximum distance between points to cause the points to be merged into a same cluster (epsilon 510). Transaction vectors combined with DBSCAN using Hamming Distance may yield groups of transactions that have similar attributes (to within a configurable tolerance/precision) while accounting for differences controlled by epsilon 510.

In a third stage of the algorithm, a partial autocorrelation function (PACF 506) may be applied to identify correlations between observations that are separated by a given number of time units (K). The system may identify timing information from the vectors in the cluster, form a temporal series, and then iteratively shift the series by a standard time unit (e.g., one day) and combine it with itself. Peaks in the resulting autocorrelation may indicate high correlation. If the cadence of this correlation matches a time interval K with a cadence such as weekly (e.g., 6-8 day interval), bi-monthly (e.g., 13-16 days), or monthly (e.g., 28-32 days), the system may classify the cluster as representing a set of recurring institutional transactions (because such transactions tend to recur on such standard intervals). In one embodiment, such transactions may be provided an anchor tag 414 in a manner similar to that described for generate anchors 412 as introduced in FIG. 4. The anchor tags 414 may in future be used to improve the efficiency, efficacy, and speed of the PACF 506.

Entire clusters representing particular types of resource transactions may move over time through the higher-dimensional space, providing visualization of resource flow trendlines. Further, these movements, as detected by efficiently capturing and tagging data that may then be preserved in a compact manner and swiftly applied or manipulated, may allow rapid comparisons between snapshots taken at certain time intervals which may then be compared in higher than three-dimensional vector space with vectors representing new transactions. In this manner, trends may be identified for use in forecasting and resource allocation management.

This may be of particular use in forecasting and managing or preparing for recurring transactions. For example, changes in a particular dimension among a cluster representing recurring monthly charges of a particular type may indicate an increase or decrease in one area of a business's planned expenses. In one embodiment, a change exceeding a configured threshold may trigger an alert to a user of a system. In another embodiment, changes in transacted amounts across various clusters may be compared, and options for reallocation of resources across categories may be recommended. These benefits may be attained even where hundreds of resource transactions in the aggregate are involved, and cannot practically be so analyzed in situ or as a function of time through reasonable human effort when represented across their disparate institutional accounting systems.

FIG. 6 illustrates an example routine 600 for for detecting, monitoring, and utilizing groups of labeled clusters representing recorded resource transfer transactions to automatically identify patterns in those transactions, in accordance with one embodiment. Although the example routine 600 depicts a particular sequence of operations, the sequence may be altered without departing from the scope of the present disclosure. For example, some of the operations depicted may be performed in parallel or in a different sequence that does not materially affect the function of the routine 600. In other examples, different components of an example device or system that implements the routine 600 may perform functions at substantially the same time or in a specific sequence.

According to some examples, the method includes receiving, using an interface, digital records from a plurality of disparate computer server systems at block 602. The disparate computer server systems may be similar to disparate computer server systems 102a through 102c, introduced and described with respect to FIG. 1. In one embodiment, before routine 1100 progresses to block 604, routine 600 may include processing the digital records through a parser to generate a large sample set, wherein each sample in the large sample set comprises a sequence of one or more symbols. The large sample set may be high-pass filtered to reduce its contents to the highest-frequency components, resulting in a filtered sample set. The filtered sample set may be utilized as the basis for mapping the digital records to the feature vectors in the higher-dimensional space. A feature vector is an ordered list of numerical properties of observed phenomena. It represents input features to a machine learning model that makes a prediction. In this disclosure, the observed phenomena are provided by the data within the digital records.

According to some examples, the method includes transforming the digital records from the disparate computer server systems into visualizations and anchor tags at block 604. This transformation may be accomplished through the steps described for subroutine block 606 through subroutine block 614. Visualizations 800 such as those illustrated in FIG. 8 may be provided to a user via a user interface. A user interface may comprise user interface logic 206 such as described with respect to FIG. 2 or user interface logic 306 such as described with respect to FIG. 3.

According to some examples, the method includes mapping the digital records to feature vectors in a higher than three-dimensional vector space at subroutine block 606. This may be performed by the mapper 402 described with respect to FIG. 4. In one embodiment, the digital records may include metadata comprising at least one of text descriptions, resource amounts, source account information, transaction dates, and institution identifiers. For example, metadata for a transaction may include text descriptions of the transaction, the resource amount, the currency used in performing the transaction, if applicable, source account information, destination account information, the date of the transaction, the institutions among whom the transaction is performed, etc. In one embodiment, blockchain data may be included in the metadata, such that a historical record of blockchain transactions associated with a resource or asset may be discoverable and may comprise characteristics of the transaction used by the disclosed algorithms for labeling and clustering. In one embodiment, mapping the digital records may comprise vectorizing the metadata, wherein the feature vectors are generated that are distributed numerical representations of the metadata. Generating the feature vectors may be accomplished using an algorithm such as word2vec.

According to some examples, the method includes forming labeled clusters of the feature vectors in the higher than three-dimensional vector space at subroutine block 608. In one embodiment, forming labeled clusters of the feature vectors may comprise computing mathematical distances between the feature vectors of the transactions in higher than three-dimensional vector space, applying hard clustering techniques to the feature vectors of the transactions in higher than three-dimensional vector space and the mathematical distances to determine clusters, wherein the clusters are similar groups of transactions, determining clusters of interest based at least in part on cluster density, and passing the clusters of interest through a summary stage comprising applying Natural Language Processing or Natural Language Understanding algorithms to each cluster of interest to label each cluster of interest based at least in part on the contents of each cluster of interest, thereby resulting in labeled clusters of the feature vectors in the higher than three-dimensional vector space. Computing the mathematical distances may be performed by distance metric 404, as described with respect to FIG. 4. Clustering 406 may apply clustering techniques, and NLP classification 408 as described in FIG. 4 may comprise or act in a manner similar to the summary stage. Similar groups of transactions may, for example, be those that occur at the same time each month and involve the same sorts of transferred resources. For example, a number of digital records may reflect lease payments that occur at the beginning of each month, though these may involve transfers to and from any number of institutions using any sort of currency. Another example of similar groups of transactions may be autopay credit payments for utilities. Clusters of interest may be determined based on user input, machine learning, or cluster attributes. Clusters of interest may be determined based at least in part on cluster density. For example, a predetermined density threshold may be configured such that clusters having a density above that threshold may be considered of interest. A user may interact with an interface to view clusters and indicate with an anchor tag that a cluster is of particular interest to them. In one embodiment, such anchor tags may be fed back and may assist the system in learning (through machine learning) what attributes may predict the user's interest. Clusters of interest may be passed through a summary stage. The summary stage may apply Natural Language Processing or Natural Language Understanding algorithms to each cluster of interest to label each cluster of interest based at least in part on the contents of each cluster of interest, thereby resulting in labeled clusters of the feature vectors in the higher than three-dimensional vector space. In one embodiment, the summary stage may include topical analysis algorithms and/or subject analysis algorithms.

According to some examples, the method includes reducing the labeled clusters to a three-dimensional vector space at subroutine block 610. In one embodiment, this may be the reduction 410 described with respect to FIG. 4. In one embodiment, reducing the labeled clusters to a three-dimensional vector space may comprise collapsing the feature vectors of the higher than three-dimensional vector space such that dimensions of the collapsed feature vectors reflect contributions from each of the higher dimensions. In one embodiment, reducing the labeled clusters may include using a t-distributed stochastic neighbor embedding algorithm.

According to some examples, the method includes identifying the anchor tags, wherein the anchor tags represent characteristics of groups of labeled clusters useful for resource management operations at subroutine block 612. In one embodiment, labels for clusters or elements within labels for a cluster that represent key similarities among the feature vectors (and thus the recorded transactions), may be identified as anchor tags. In another embodiment, a pre-determined set of anchor tags of particular interest in an application of the system may be provided, and may be identified as pertinent to a labeled cluster based on the characteristics related to the anchor tag being present in a number of feature vectors within the cluster above a predetermined threshold. This may be performed by the generate anchors 412 algorithm described with respect to FIG. 4.

According to some examples, the method includes presenting the visualizations and the anchor tags to a user for selection of the anchor tag at subroutine block 614. Exemplary visualizations 800 may be seen in FIG. 8. Additional user interface displays or visualizations may include the dynamic preview window 324 illustrated in FIG. 3. Each of these examples shows controls by which a user may interact with and create anchor tags.

According to some examples, the method includes applying the anchor tags to labeled clusters and facilitate resource management operations at block 616. Application of anchor tags and facilitation of resource management options may be performed as described with respect to subroutine block 618 through subroutine block 624.

According to some examples, the method includes receiving an anchor tag selection signal from the user indicating selecting a suggested anchor tag, creating a custom anchor tag, or selecting no anchor tag at subroutine block 618. In one embodiment, the anchor tag selection signal may be provided by a user via a user interface. Identified anchor tags may be displayed to the user as part of the visualizations 800 of FIG. 8, the dynamic preview window 324 illustrated in FIG. 3, or some other manner which allows the user to view identified tags. A tag creation control may be implemented in the user interface allowing the user to create their own custom anchor tag. The user may be permitted to interact with the system without either selecting or creating an anchor tag, resulting in an anchor tag selection signal indicating selecting no anchor tag.

According to some examples, the method includes applying the anchor tag to the group of labeled clusters based on the anchor tag selection signal, thereby creating an anchor tagged group of labeled clusters at subroutine block 620. In one embodiment, in addition to applying anchor tags to clusters based on this signal, the system may feed selected and custom anchor tag information back to earlier stages of the process, as indicated with the anchor tags 414 shown in FIG. 4. For example, anchor tags may be fed back as potential labels. This anchor tag information may allow the system to refine its clustering, labeling, and anchor tag identification abilities over time, improving the efficiency, efficacy, and usability of the system.

According to some examples, the method includes generating a cluster monitoring signal based on an applied anchor tag at subroutine block 622. According to some examples, the method includes initiating the resource management operations based on the cluster monitoring signal at subroutine block 624. In one embodiment, routine 600 may further comprise identifying additional labeled clusters representing new digital records, over time, that have received the applied anchor tag and have been made a part of the anchor tagged group of labeled clusters. The resource management operations may include monitoring the anchor tagged group of labeled clusters for movement over time, and, on condition the anchor tagged group of labeled clusters moves beyond a predetermined threshold, initiating a management action to mitigate the movement. In one embodiment, the management action to mitigate the movement may include at least one of forecasting and preparing for at least one of a reallocation of resources into an account linked to the digital records, and the reallocation of resources out of the account linked to the digital records. In one embodiment, initiating the management action may comprise releasing a gate to at least one of initiate a reallocation of resources into an account linked to the digital records and initiate the reallocation of resources out of the account linked to the digital records. In one embodiment, the resources are at least one of monetary funds and other digitally represented assets. Resources may further include digitally-transferable property assets of types other than money or currency. In one embodiment, the resources may be budgetary; that is, future, planned, or forecasted resources or assets may be reallocated to mitigate a detected or predicted movement over time of the group of labeled clusters. In another embodiment, the movement of a monitored group of clusters may be used to generate an alert to a user. The movement may additionally or alternatively be logged for future reference, and/or used in forecasting, planning, and reporting operations.

FIG. 7 illustrates an example routine 700 for detecting, monitoring, and utilizing time-recurrent labeled clusters representing recorded time-recurrent resource transfer transactions, in accordance with one embodiment. Although the example routine 700 depicts a particular sequence of operations, the sequence may be altered without departing from the scope of the present disclosure. For example, some of the operations depicted may be performed in parallel or in a different sequence that does not materially affect the function of the routine 700. In other examples, different components of an example device or system that implements the routine 700 may perform functions at substantially the same time or in a specific sequence.

According to some examples, the method includes receiving, via an interface, digital records from a plurality of disparate computer server systems at block 702. The disparate computer server systems may be similar to disparate computer server systems 102a through 102c, introduced and described with respect to FIG. 1. In one embodiment, before routine 700 progresses to block 704, routine 700 may include processing the digital records through a parser to generate a large sample set, wherein each sample in the large sample set comprises a sequence of one or more symbols. The large sample set may be high-pass filtered to reduce its contents to the highest-frequency components, resulting in a filtered sample set. The filtered sample set may be utilized as the basis for mapping the digital records to the feature vectors in the higher-dimensional space. A feature vector is an ordered list of numerical properties of observed phenomena. It represents input features to a machine learning model that makes a prediction. In this disclosure, the observed phenomena are provided by the data within the digital records.

According to some examples, the method includes transforming the digital records from the disparate computer server systems into visualizations and anchor tags at block 704. This transformation may be accomplished through the steps described for subroutine block 706 through subroutine block 716. Visualizations 800 such as those illustrated in FIG. 8 may be provided to a user via a user interface. A user interface may comprise user interface logic 206 such as described with respect to FIG. 2 or user interface logic 306 such as described with respect to FIG. 3.

According to some examples, the method includes mapping the digital records to feature vectors in a higher than three-dimensional vector space at subroutine block 706. This may be performed by the mapper 402 described with respect to FIG. 4 and as shown in FIG. 5. In one embodiment, the digital records include metadata comprising at least one of text descriptions, resource amounts, source account information, transaction dates, and institution identifiers. For example, metadata for a transaction may include text descriptions of the transaction, the resource amount, the currency used in performing the transaction, if applicable, source account information, destination account information, the date of the transaction, the institutions among whom the transaction is performed, etc. In one embodiment, blockchain data may be included in the metadata, such that a historical record of blockchain transactions associated with a resource or asset may be discoverable and may comprise characteristics of the transaction used by the disclosed algorithms for labeling and clustering. In one embodiment, mapping the digital records may comprise vectorizing the metadata, wherein the feature vectors are generated that are distributed numerical representations of the metadata. In one embodiment, generating the feature vectors includes utilizing word2vec.

According to some examples, the method includes calculating hamming distances between the feature vectors at subroutine block 708. This may be performed as the distance metric 502 determination as described with respect to FIG. 5.

According to some examples, the method includes forming labeled clusters of the feature vectors in the higher than three-dimensional vector space using a DBSCAN algorithm and the hamming distances at subroutine block 710. This may be performed using DBSCAN 504 as described with respect to FIG. 5. In one embodiment, forming labeled clusters of the vectors may comprise providing the DBSCAN algorithm with a minimum number of data points that make up a cluster and a maximum distance between points in order to merge it into the cluster. These parameters may be the min_n 508 and epsilon 510 shown in FIG. 5, respectively. The maximum distance may be determined at least in part from the Hamming distances. After executing the DBSCAN algorithm, clusters of interest may be received and may be passed through a summary stage. The summary stage may apply a labeling algorithm to the clusters of interest to generate labeled clusters of feature vectors in the higher than three-dimensional vector space. The labeling algorithm may comprise at least one of Natural Language Processing algorithms, Natural Language Understanding algorithms, topical analysis algorithms, and subject analysis algorithms.

According to some examples, the method includes autocorrelating the labeled clusters having common characteristics to identify transactions that recur on a predetermined time interval, identifying time-recurrent labeled clusters at subroutine block 712. This may be performed using PACF 506 as described with respect to FIG. 5. In one embodiment, autocorrelating the labeled clusters having common characteristics may include identifying transaction dates from the feature vectors in the labeled clusters, forming a temporal series based at least in part on the transaction dates, applying a partial autocorrelation function (PACF) to the temporal series to determine transaction intervals, wherein the transaction intervals exhibit high correlation of the feature vectors of the temporal series, comparing the transaction intervals to K, wherein K is a time interval representing a cadence useful for resource management operations, and, on condition the transaction intervals fall within K, identifying the labeled clusters as the time-recurrent labeled clusters. Cadences useful for resource management operations may include those indicative of weekly transactions, bi-monthly transactions, monthly transactions, etc.

According to some examples, the method includes identifying the anchor tags representing characteristics of groups of time-recurrent labeled clusters useful for resource management operations at subroutine block 714. In one embodiment, labels for clusters or elements within labels for a time-recurrent labeled cluster that represent key similarities among the feature vectors (and thus the recorded transactions), may be identified as anchor tags. In another embodiment, a pre-determined set of anchor tags of particular interest in an application of the system may be provided, and may be identified as pertinent to a labeled cluster based on the characteristics related to the anchor tag being present in a number of feature vectors within the cluster above a predetermined threshold.

According to some examples, the method includes presenting the visualizations and the anchor tags to a user for selection of the anchor tag at subroutine block 716. In one embodiment, the feature vectors comprising the time-recurrent labeled clusters may be reduced to three-dimensional space for simpler presentation and visualization by a user. This may be performed in a manner similar to that described with respect to the routine 1100 illustrated in FIG. 6. Exemplary visualizations 800 may be seen in FIG. 8. Additional user interface displays or visualizations may include the dynamic preview window 324 illustrated in FIG. 3. Each of these examples shows controls by which a user may interact with and create anchor tags.

According to some examples, the method includes applying the anchor tags to the time-recurrent labeled clusters and facilitate resource management operations at block 718. Application of anchor tags and facilitation of resource management operations may be accomplished through the steps described for subroutine block 720 through subroutine block 726.

According to some examples, the method includes receiving an anchor tag selection signal from the user indicating selecting a suggested anchor tag, creating a custom anchor tag, or selecting no anchor tag at subroutine block 720.

According to some examples, the method includes applying the anchor tag to the group of time-recurrent labeled clusters based on the anchor tag selection signal, creating an anchor tagged group of time-recurrent labeled clusters at subroutine block 722. In one embodiment, in addition to applying anchor tags to clusters based on this signal, the system may feed selected and custom anchor tag information back to earlier stages of the process, as indicated with the anchor tags 414 shown in FIG. 5. For example, anchor tags may be fed back as potential labels. This anchor tag information may allow the system to refine its clustering, labeling, and anchor tag identification abilities over time, improving the efficiency, efficacy, and usability of the system.

According to some examples, the method includes generating a time-recurrent cluster monitoring signal based on an applied anchor tag at subroutine block 724. According to some examples, the method includes initiating the resource management operations based on the time-recurrent cluster monitoring signal at subroutine block 726. In one embodiment, routine 1200 may include identifying additional time-recurrent labeled clusters representing new digital records, over time, that have received the applied anchor tag and have been made a part of the anchor tagged group of time-recurrent labeled clusters. The resource management operations may include monitoring the anchor tagged group of time-recurrent labeled clusters for movement over time and, on condition the anchor tagged group of time-recurrent labeled clusters moves beyond a predetermined threshold, initiating a management action to mitigate the movement. In one embodiment, the management action to mitigate the movement may include at least one of forecasting and preparing for at least one of a reallocation of resources into an account linked to the digital records and the reallocation of resources out of the account linked to the digital records. In one embodiment, initiating the management action may comprise releasing a gate to at least one of initiate a reallocation of resources into an account linked to the digital records and initiate the reallocation of resources out of the account linked to the digital records. In one embodiment, the resources are at least one of monetary funds and other digitally represented assets.

FIG. 8 depicts visualizations 800 in accordance with one embodiment. The visualizations 800 show a transactions explorer 802 which may include an interactive 3D plot 804 and a summary output 806 view.

As described with respect to FIG. 4, reducing the number of dimensions operated upon by the logic process 400 to three may allow more efficient visualization of the distribution without excessive filtering or interactivity to establish placement. For example, the interactive 3D plot 804 may readily provide an interactive visualization of clusters 808 and group of clusters 810, as well as a visualization of various cluster attribute distributions. Outputs from the topical analysis stage, such as the automatic payment credited to your account (autopay cr) recommended tag search terms shown in the summary output 806 for a group or cluster, may be applied as “anchor tags” in normalized aggregated inputs from distributed online systems, to enable more efficient indexing and scalability in the system, and to forecast and manage future resource inflows and outflows.

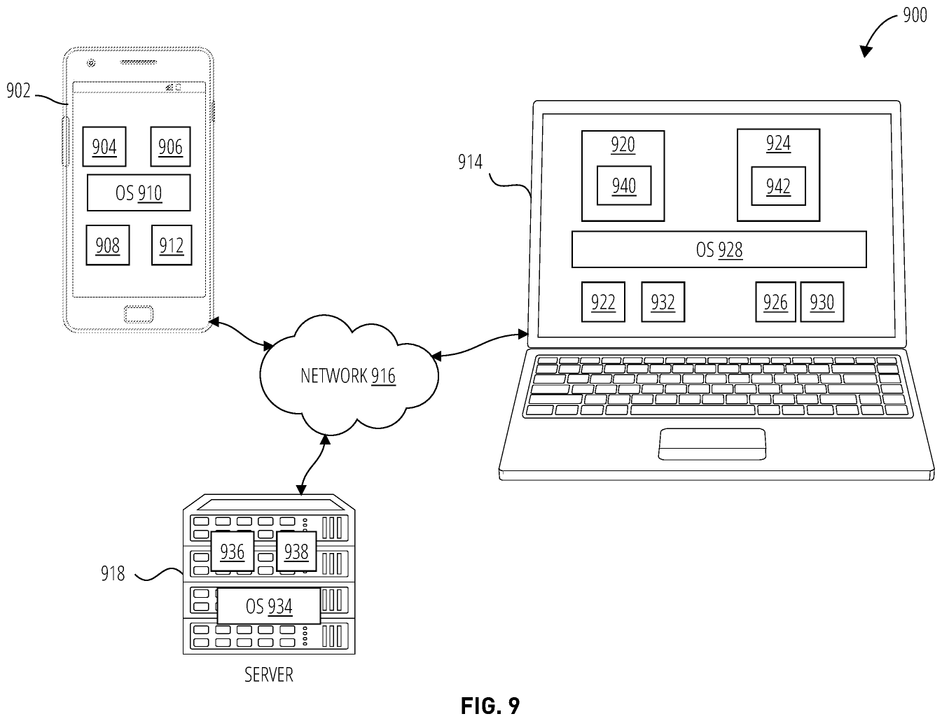

Referring to FIG. 9, a client server network configuration 900 illustrates various computer hardware devices and software modules coupled by a network 916 in one embodiment. Each device includes a native operating system, typically pre-installed on its non-volatile RAM, and a variety of software applications or apps for performing various functions.

The mobile programmable device 902 comprises a native operating system 910 and various apps (e.g., app 904 and app 906). A computer 914 also includes an operating system 928 that may include one or more libraries of native routines to run executable software on that device. The computer 914 also includes various executable applications (e.g., application 920 and application 924). The mobile programmable device 902 and computer 914 are configured as clients on the network 916. A server 918 is also provided and includes an operating system 934 with native routines specific to providing a service (e.g., service 938 and service 936) available to the networked clients in this configuration.

As is well known in the art, an application, an app, or a service may be created by first writing computer code to form a computer program, which typically comprises one or more computer code sections or modules. Computer code may comprise instructions in many forms, including source code, assembly code, object code, executable code, and machine language. The term “computer code” refers to any of source code, object code, or executable code. The term “assembly code” refers to a low-level source code language comprising a strong correspondence between the source code statements and machine language instructions. Assembly code is converted into executable code by an assembler. The conversion process is referred to as assembly. Assembly language usually has one statement per machine language instruction, but comments and statements that are assembler directives, macros, and symbolic labels may also be supported. Computer programs often implement mathematical functions or algorithms and may implement or utilize one or more application programming interfaces. “Application programming interface” refers to instructions implementing entry points and return values to a module. The term “machine language” refers to Instructions in a form that is directly executable by a programmable device without further translation by a compiler, interpreter, or assembler. In digital devices, machine language instructions are typically sequences of ones and zeros.

A compiler is typically used to transform source code into object code and thereafter a linker combines object code files into an executable application, recognized by those skilled in the art as an “executable”. “Compiler” refers to Logic that transforms source code from a high-level programming language into object code or in some cases, into executable code.

The distinct file comprising the executable would then be available for use by the computer 914, mobile programmable device 902, and/or server 918. Any of these devices may employ a loader to place the executable and any associated library in memory for execution. The operating system executes the program by passing control to the loaded program code, creating a task or process. An alternate means of executing an application or app involves the use of an interpreter (e.g., interpreter 942). The term “linker” refers to Logic that inputs one or more object code files generated by a compiler or an assembler and combines them into a single executable, library, or other unified object code output. One implementation of a linker directs its output directly to machine memory as executable code (performing the function of a loader as well). The term “library” refers to a collection of modules organized such that the functionality of all the modules may be included for use by software using references to the library in source code. The term “object code” refers to the computer code output by a compiler or as an intermediate output of an interpreter. “Computer code” refers to any of source code, object code, or executable code. Object code often takes the form of machine language or an intermediate language such as register transfer language (RTL).

In addition to executing applications (“apps”) and services, the operating system is also typically employed to execute drivers to perform common tasks such as connecting to third-party hardware devices (e.g., printers, displays, input devices), storing data, interpreting commands, and extending the capabilities of applications. For example, a driver 908 or driver 912 on the mobile programmable device 902 or computer 914 (e.g., driver 922 and driver 932) might enable wireless headphones to be used for audio output(s) and a camera to be used for video inputs. Any of the devices may read and write data from and to files (e.g., file 926 or file 930) and applications or apps may utilize one or more plug-in (e.g., plug-in 940) to extend their capabilities (e.g., to encode or decode video files). The term “operating system” refers to logic, typically software, that supports a device's basic functions, such as scheduling tasks, managing files, executing applications, and interacting with peripheral devices. In normal parlance, an application is said to execute “above” the operating system, meaning that the operating system is needed to load and execute the application and the application relies on modules of the operating system in most cases, not vice-versa. The operating system also typically intermediates between applications and drivers. Drivers are said to execute “below” the operating system because they intermediate between the operating system and hardware components or peripheral devices. The term “plug-in” refers to software that adds features to an existing computer program without rebuilding (e.g., changing or re-compiling) the computer program. Plug-ins are commonly used for example with Internet browser applications.

The network 916 in the client server network configuration 900 may be of a type understood by those skilled in the art, including a Local Area network (LAN), Wide Area network (WAN), Transmission Communication Protocol/Internet Protocol (TCP/IP) network, and so forth. These protocols used by the network 916 dictate the mechanisms by which data is exchanged between devices.

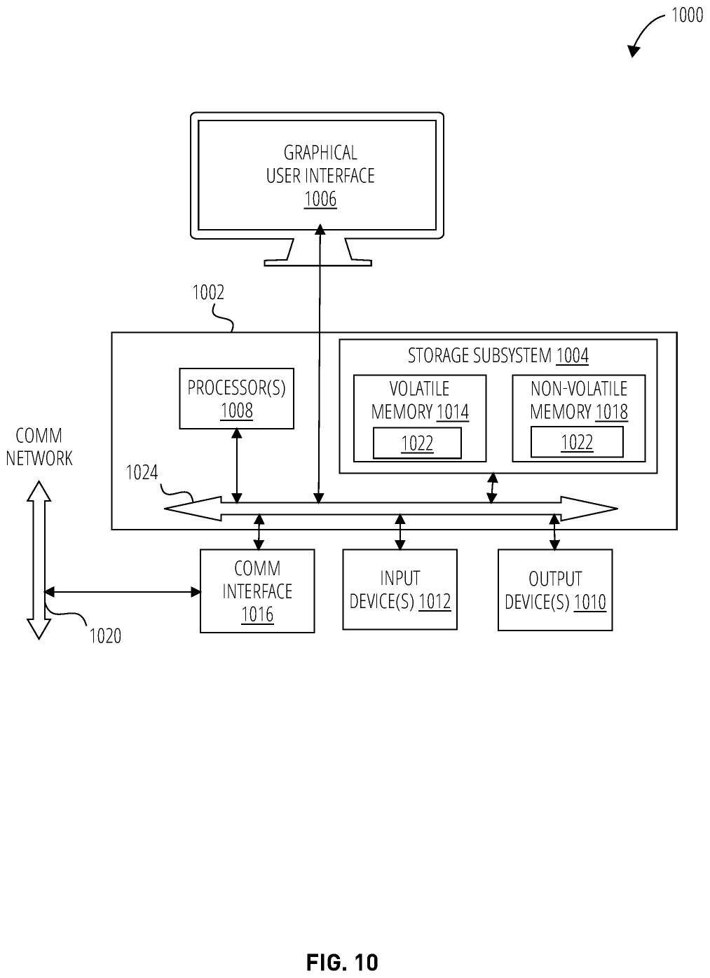

FIG. 10 is an example block diagram of a computing device 1000 that may incorporate embodiments of the claimed solution. FIG. 10 is merely illustrative of a machine system to carry out aspects of the technical processes described herein, and does not limit the scope of the claims. One of ordinary skill in the art would recognize other variations, modifications, and alternatives. In certain embodiments, the computing device 1000 includes a graphical user interface 1006, a data processing system 1002, a communication network 1020, communication network interface 1016, input device(s) 1012, output device(s) 1010, and the like.

As depicted in FIG. 10, the data processing system 1002 may include one or more processor(s) 1008 and a storage subsystem 1004. “Processor” refers to “Processor” refers to any circuitry, component, chip, die, package, or module configured to receive, interpret, decode, and execute machine instructions. Examples of a processor may include, but are not limited to, a central processing unit, a general-purpose processor, an application-specific processor, a graphics processing unit (GPU), a field programmable gate array (FPGA), application Specific Integrated Circuit (ASIC), System on a Chip (SoC), virtual processor, processor core, and the like. The processor(s) 1008 communicate with a number of peripheral devices via a bus subsystem 1024. These peripheral devices may include input device(s) 1012, output device(s) 1010, communication network interface 1016, and the storage subsystem 1004. The storage subsystem 1004, In one embodiment, comprises one or more storage devices and/or one or more memory devices. “Memory” refers to “Memory” refers to any hardware, circuit, component, module, logic, device, or apparatus configured, programmed, designed, arranged, or engineered to retain data. Certain types of memory require availability of a constant power source to store and retain the data. Other types of memory retain and/or store the data when a power source is unavailable. The term “storage device” refers to any hardware, system, sub-system, circuit, component, module, non-volatile memory media, hard disk drive, storage array, device, or apparatus configured, programmed, designed, or engineered to store data for a period of time and retain the data in the storage device while the storage device is not using power from a power supply. Examples of storage devices include, but are not limited to, a hard disk drive, FLASH memory, MRAM memory, a Solid-State storage device, Just a Bunch Of Disks (JBOD), Just a Bunch Of Flash (JBOF), an external hard disk, an internal hard disk, and the like.

In one embodiment, the storage subsystem 1004 includes a volatile memory 1014 and a non-volatile memory 1018. The term “volatile memory” refers to a shorthand name for volatile memory media. In certain embodiments, volatile memory refers to the volatile memory media and the logic, controllers, processor(s), state machine(s), and/or other periphery circuits that manage the volatile memory media and provide access to the volatile memory media. The term “non-volatile memory” refers to shorthand name for non-volatile memory media. In certain embodiments, non-volatile memory media refers to the non-volatile memory media and the logic, controllers, processor(s), state machine(s), and/or other periphery circuits that manage the non-volatile memory media and provide access to the non-volatile memory media. The volatile memory 1014 and/or the non-volatile memory 1018 may store computer-executable instructions that alone or together form logic 1022 that when applied to, and executed by, the processor(s) 1008 implement embodiments of the processes disclosed herein. The term “logic” refers to machine memory circuits, non-transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

The input device(s) 1012 include devices and mechanisms for inputting information to the data processing system 1002. These may include a keyboard, a keypad, a touch screen incorporated into the graphical user interface 1006, audio input devices such as voice recognition systems, microphones, and other types of input devices. In various embodiments, the input device(s) 1012 may be embodied as a computer mouse, a trackball, a track pad, a joystick, wireless remote, drawing tablet, voice command system, eye tracking system, and the like. The input device(s) 1012 typically allow a user to select objects, icons, control areas, text and the like that appear on the graphical user interface 1006 via a command such as a click of a button or the like.

The output device(s) 1010 include devices and mechanisms for outputting information from the data processing system 1002. These may include the graphical user interface 1006, speakers, printers, infrared LEDs, and so on, as well understood in the art. In certain embodiments, the graphical user interface 1006 is coupled to the bus subsystem 1024 directly by way of a wired connection. In other embodiments, the graphical user interface 1006 couples to the data processing system 1002 by way of the communication network interface 1016. For example, the graphical user interface 1006 may comprise a command line interface on a separate computing device 1000 such as desktop, server, or mobile device. A graphical user interface 1006 may comprise one example of, or one component of a user interface. “User interface” refers to “User interface” refers to a set of logic, components, devices, software, firmware, and peripherals configured to facilitate interactions between humans and machines and/or computing devices.

The communication network interface 1016 provides an interface to communication networks (e.g., communication network 1020) and devices external to the data processing system 1002. The communication network interface 1016 may serve as an interface for receiving data from and transmitting data to other systems. Embodiments of the communication network interface 1016 may include an Ethernet interface, a modem (telephone, satellite, cable, ISDN), (asynchronous) digital subscriber line (DSL), FireWire, USB, a wireless communication interface such as Bluetooth or WiFi, a near field communication wireless interface, a cellular interface, and the like.

The communication network interface 1016 may be coupled to the communication network 1020 via an antenna, a cable, or the like. In some embodiments, the communication network interface 1016 may be physically integrated on a circuit board of the data processing system 1002, or in some cases may be implemented in software or firmware, such as “soft modems”, or the like.

The computing device 1000 may include logic that enables communications over a network using protocols such as HTTP, TCP/IP, RTP/RTSP, IPX, UDP and the like.

The volatile memory 1014 and the non-volatile memory 1018 are examples of tangible media configured to store computer readable data and instructions to implement various embodiments of the processes described herein. Other types of tangible media include removable memory (e.g., pluggable USB memory devices, mobile device SIM cards), optical storage media such as CD-ROMS, DVDs, semiconductor memories such as flash memories, non-transitory read-only-memories (ROMS), battery-backed volatile memories, networked storage devices, and the like. The volatile memory 1014 and the non-volatile memory 1018 may be configured to store the basic programming and data constructs that provide the functionality of the disclosed processes and other embodiments thereof that fall within the scope of the present disclosure.

Logic 1022 that implements one or more parts of embodiments of the solution may be stored in the volatile memory 1014 and/or the non-volatile memory 1018. Logic 1022 may be read from the volatile memory 1014 and/or non-volatile memory 1018 and executed by the processor(s) 1008. The volatile memory 1014 and the non-volatile memory 1018 may also provide a repository for storing data used by the logic 1022.

The volatile memory 1014 and the non-volatile memory 1018 may include a number of memories including a main random-access memory (RAM) for storage of instructions and data during program execution and a read only memory (ROM) in which read-only non-transitory instructions are stored. The volatile memory 1014 and the non-volatile memory 1018 may include a file storage subsystem providing persistent (non-volatile) storage for program and data files. The volatile memory 1014 and the non-volatile memory 1018 may include removable storage systems, such as removable flash memory.

The bus subsystem 1024 provides a mechanism for enabling the various components and subsystems of data processing system 1002 communicate with each other as intended. Although the communication network interface 1016 is depicted schematically as a single bus, some embodiments of the bus subsystem 1024 may utilize multiple distinct busses.

It will be readily apparent to one of ordinary skill in the art that the computing device 600 may be a device such as a smartphone, a desktop computer, a laptop computer, a rack-mounted computer system, a computer server, or a tablet computer device. As commonly known in the art, the computing device 1000 may be implemented as a collection of multiple networked computing devices. Further, the computing device 1000 will typically include operating system logic (not illustrated) the types and nature of which are well known in the art.

Terms used herein should be accorded their ordinary meaning in the relevant arts, or the meaning indicated by their use in context, but if an express definition is provided, that meaning controls.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical, such as an electronic circuit). More specifically, this formulation is used to indicate that this structure is arranged to perform the one or more tasks during operation. A structure may be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 412(f) for that claim element. Accordingly, claims in this application that do not otherwise include the “means for” [performing a function] construct should not be interpreted under 35 U.S.C § 412(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” may be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of disclosed subject matter is not limited to the depicted embodiments but is rather set forth in the following Claims.

What is claimed is:

1. A system comprising:
an interface coupled to receive digital records from a plurality of disparate computer server systems, wherein the interface includes an ingest module;
an outflow module comprising logic to transform the digital records from the disparate computer server systems into visualizations and anchor tags by:
mapping the digital records to feature vectors in a higher than three-dimensional vector space;
calculating Hamming distances between the feature vectors;
forming labeled clusters of the feature vectors in the higher than three-dimensional vector space using:
a density-based spatial clustering of applications with noise (DBSCAN) algorithm; and
the Hamming distances;
autocorrelating the labeled clusters having common characteristics to identify transactions that recur on a predetermined time interval, thereby identifying time-recurrent labeled clusters; and
identifying the anchor tags, wherein the anchor tags represent characteristics of groups of time-recurrent labeled clusters useful for resource management operations; and
user interface logic to apply the anchor tags to the time-recurrent labeled clusters and to facilitate resource management operations by:
presenting the visualizations and the anchor tags to a user for selection of the anchor tag;
receiving an anchor tag selection signal from the user comprising at least one of:
selecting a suggested anchor tag;
creating a custom anchor tag; and
selecting no anchor tag;
applying the anchor tag to the group of time-recurrent labeled clusters based on the anchor tag selection signal, thereby creating an anchor tagged group of time-recurrent labeled clusters;
generating a time-recurrent cluster monitoring signal based on an applied anchor tag; and
initiating the resource management operations based on the time-recurrent cluster monitoring signal, thereby improving operational efficiencies of at least one of the ingest module and the outflow module by improving at least one of communication and operational bandwidth, system stability, and latency between the ingest module and the outflow module.

2. The system of claim 1, further comprising:
identifying additional time-recurrent labeled clusters representing new digital records, over time, that have received the applied anchor tag and have been made a part of the anchor tagged group of time-recurrent labeled clusters;
wherein the resource management operations include:
monitoring the anchor tagged group of time-recurrent labeled clusters for movement over time; and
on condition the anchor tagged group of time-recurrent labeled clusters moves beyond a predetermined threshold:
initiating a management action to mitigate the movement.

3. The system of claim 2, wherein the management action to mitigate the movement includes at least one of forecasting and preparing for at least one of:
a reallocation of resources into an account linked to the digital records; and
the reallocation of resources out of the account linked to the digital records.

4. The system of claim 2, wherein initiating the management action comprises releasing a gate to at least one of:
initiate a reallocation of resources into an account linked to the digital records; and
initiate the reallocation of resources out of the account linked to the digital records.

5. The system of claim 4, wherein the resources are at least one of monetary funds and other digitally represented assets.

6. The system of claim 1, wherein:
the digital records include metadata comprising at least one of:
text descriptions;
resource amounts;
source account information;
transaction dates; and
institution identifiers; and
mapping the digital records comprises vectorizing the metadata, wherein the feature vectors are generated that are distributed numerical representations of the metadata.

7. The system of claim 6, wherein generating the feature vectors includes utilizing word2vec.

8. The system of claim 1, further comprising, prior to the logic to transform the digital records from the disparate computer server systems into visualizations and anchor tags, logic for:
processing the digital records through a parser to generate a large sample set, wherein each sample in the large sample set comprises a sequence of one or more symbols;
high-pass filtering the large sample set to reduce its contents to the highest-frequency components, resulting in a filtered sample set; and
utilizing the filtered sample set as the basis for mapping the digital records to the feature vectors in the higher-dimensional space.

9. The system of claim 1, wherein forming labeled clusters of the vectors comprises:
providing the DBSCAN algorithm with:
a minimum number of data points that make up a cluster; and
a maximum distance between points in order to merge it into the cluster, wherein the maximum distance is determined at least in part from the Hamming distances;
receiving clusters of interest after executing the DBSCAN algorithm; and
passing the clusters of interest through a summary stage comprising:
applying a labeling algorithm to the clusters of interest to generate labeled clusters of feature vectors in the higher than three-dimensional vector space, wherein the labeling algorithm comprises at least one of:
Natural Language Processing algorithms;
Natural Language Understanding algorithms;
topical analysis algorithms; and
subject analysis algorithms.

10. The system of claim 1, wherein autocorrelating the labeled clusters having common characteristics includes:
identifying transaction dates from the feature vectors in the labeled clusters;
forming a temporal series based at least in part on the transaction dates;
applying a partial autocorrelation function (PACF) to the temporal series to determine transaction intervals, wherein the transaction intervals exhibit high correlation of the feature vectors of the temporal series;
comparing the transaction intervals to K, wherein K is a time interval representing a cadence useful for resource management operations; and
on condition the transaction intervals fall within K:
identifying the labeled clusters as the time-recurrent labeled clusters.

11. A method comprising:
receiving, via an interface, digital records from a plurality of disparate computer server systems, wherein the interface includes an ingest module;
transforming, using an outflow module, the digital records from the disparate computer server systems into visualizations and anchor tags by:
mapping the digital records to feature vectors in a higher than three-dimensional vector space;
calculating Hamming distances between the feature vectors;
forming labeled clusters of the feature vectors in the higher than three-dimensional vector space using:
a density-based spatial clustering of applications with noise (DBSCAN) algorithm; and
the Hamming distances;
autocorrelating the labeled clusters having common characteristics to identify transactions that recur on a predetermined time interval, thereby identifying time-recurrent labeled clusters; and
identifying the anchor tags, wherein the anchor tags represent characteristics of groups of time-recurrent labeled clusters useful for resource management operations; and
applying, using user interface logic, the anchor tags to the time-recurrent labeled clusters and facilitating resource management operations by:
presenting the visualizations and the anchor tags to a user for selection of the anchor tag;
receiving an anchor tag selection signal from the user comprising at least one of:
selecting a suggested anchor tag;
creating a custom anchor tag; and
selecting no anchor tag;
applying the anchor tag to the group of time-recurrent labeled clusters based on the anchor tag selection signal, thereby creating an anchor tagged group of time-recurrent labeled clusters;
generating a time-recurrent cluster monitoring signal based on an applied anchor tag; and
initiating the resource management operations based on the time-recurrent cluster monitoring signal, thereby improving operational efficiencies of at least one of the ingest module and the outflow module by improving at least one of communication and operational bandwidth, system stability, and latency between the ingest module and the outflow module.

12. The method of claim 11, further comprising:
identifying additional time-recurrent labeled clusters representing new digital records, over time, that have received the applied anchor tag and have been made a part of the anchor tagged group of time-recurrent labeled clusters;
wherein the resource management operations include:
monitoring the anchor tagged group of time-recurrent labeled clusters for movement over time; and
on condition the anchor tagged group of time-recurrent labeled clusters moves beyond a predetermined threshold:
initiating a management action to mitigate the movement.

13. The method of claim 12, wherein the management action to mitigate the movement includes at least one of forecasting and preparing for at least one of:
a reallocation of resources into an account linked to the digital records; and
the reallocation of resources out of the account linked to the digital records.

14. The method of claim 12, wherein initiating the management action comprises releasing a gate to at least one of:
initiate a reallocation of resources into an account linked to the digital records; and
initiate the reallocation of resources out of the account linked to the digital records.

15. The method of claim 14, wherein the resources are at least one of monetary funds and other digitally represented assets.

16. The method of claim 11, wherein:
the digital records include metadata comprising at least one of:
text descriptions;
resource amounts;
source account information;
transaction dates; and
institution identifiers; and
mapping the digital records comprises vectorizing the metadata, wherein the feature vectors are generated that are distributed numerical representations of the metadata.

17. The method of claim 16, wherein generating the feature vectors includes utilizing word2vec.

18. The method of claim 11, further comprising, prior to transforming the digital records from the disparate computer server systems into visualizations and anchor tags:
processing the digital records through a parser to generate a large sample set, wherein each sample in the large sample set comprises a sequence of one or more symbols;
high-pass filtering the large sample set to reduce its contents to the highest-frequency components, resulting in a filtered sample set; and
utilizing the filtered sample set as the basis for mapping the digital records to the feature vectors in the higher-dimensional space.

19. The method of claim 11, wherein forming labeled clusters of the vectors comprises:
providing the DBSCAN algorithm with:
a minimum number of data points that make up a cluster; and
a maximum distance between points in order to merge it into the cluster, wherein the maximum distance is determined at least in part from the Hamming distances;
receiving clusters of interest after executing the DBSCAN algorithm; and
passing the clusters of interest through a summary stage comprising:
applying a labeling algorithm to the clusters of interest to generate labeled clusters of feature vectors in the higher than three-dimensional vector space, wherein the labeling algorithm comprises at least one of:
Natural Language Processing algorithms;
Natural Language Understanding algorithms;
topical analysis algorithms; and
subject analysis algorithms.

20. The method of claim 11, wherein autocorrelating the labeled clusters having common characteristics includes:
identifying transaction dates from the feature vectors in the labeled clusters;
forming a temporal series based at least in part on the transaction dates;
applying a partial autocorrelation function (PACF) to the temporal series to determine transaction intervals, wherein the transaction intervals exhibit high correlation of the feature vectors of the temporal series;
comparing the transaction intervals to K, wherein K is a time interval representing a cadence useful for resource management operations; and
on condition the transaction intervals fall within K:
identifying the labeled clusters as the time-recurrent labeled clusters.
